(19) United States
(12) Patent Application Publication
(10) Pub. No.: US 2020/0117059 A1
(43) Pub. Date: Apr. 16, 2020

(54) DISPLAY PANEL AND DISPLAY DEVICE

(71) Applicants: HKC Corporation Limited, Shenzhen (CN); Chongqing HKC Optoelectronics Technology Co., Ltd., Chongqing (CN)

(72) Inventor: Yanna Yang, Shenzhen (CN)

(21) Appl. No.: 16/446,645

(22) Filed: Jun. 20, 2019

Related U.S. Application Data
(63) Continuation of application No. PCT/CN2018/119172, filed on Dec. 4, 2018.

(30) Foreign Application Priority Data
Oct. 15, 2018 (CN) 201811199730.3

(51) Int. Cl. G02F 1/1343; G02F 1/1362

(52) U.S. Cl. CPC G02F 1/134309; G02F 2001/134345; G02F 1/136286

(57) ABSTRACT

The present disclosure provides a display panel and a display device, the display panel includes a plurality of first sub pixel electrodes and a plurality of second sub pixel electrodes, the first sub pixel electrodes and the second sub pixel electrodes are arranged in a rectangular array; a plurality of first auxiliary electrodes, the first auxiliary electrodes at least partially surround the plurality of first sub pixel electrodes, the first auxiliary electrodes and the first sub pixel electrodes have opposite polarities; and a plurality of second auxiliary electrodes, the second auxiliary electrodes at least partially surround the plurality of second sub pixel electrodes, the second auxiliary electrodes and the second sub pixel electrodes have opposite polarities.

### CROSS-REFERENCE TO RELATED PRESENT DISCLOSURES

The present application is a Continuation Application of International Application No. PCT/CN2018/119172, filed Dec. 4, 2018, which claims the benefit of China Patent present disclosure No. CN201811199730.3, filed Oct. 15, 2018, with the State Intellectual Property Office and entitled “display panel, and display device”, the entirety of which is hereby incorporated herein by reference.

### TECHNICAL FIELD

The present disclosure generally relates to the technical field of display, and more particularly relates to a display panel, and a display device.

### BACKGROUND

The statements herein merely provide background information related to the present disclosure and do not necessarily constitute prior art.

The technique of increasing the quantity of pixel electrode domains is generally adopted to increase the view angle of the display panel and improve the image display quality. In the prior art, protrusions are usually defined on the upper and lower substrates, and then a vertical alignment film is covered on the protrusions, so that vertically aligned liquid crystal molecules have pre-tilt angles inclined in different directions when no voltage is applied, thereby controlling the tilt directions of the liquid crystal molecules after the voltage is applied. However, for this kind of structure, when no voltage is applied, the alignment of the liquid crystal may not be completely vertical due to the domain boundary regulation structure, so the light paths of the light passing through the tilted liquid crystal molecules may have excessive optical path difference, resulting in light leakage.

### SUMMARY

It is therefore one main object of the disclosure to provide a display panel, which aims to improve the image display quality of the display panel and avoid light leakage.

In order to realize the above aim, the present disclosure provides a display panel, the display panel includes:

a plurality of first sub pixel electrodes and a plurality of second sub pixel electrodes, the first sub pixel electrodes and the second sub pixel electrodes are arranged in a rectangular array;

a plurality of first auxiliary electrodes, the first auxiliary electrodes at least partially surround the plurality of first sub pixel electrodes, the first auxiliary electrodes and the first sub pixel electrodes have opposite polarities; and

a plurality of second auxiliary electrodes, the second auxiliary electrodes at least partially surround the plurality of second sub pixel electrodes, the second auxiliary electrodes and the second sub pixel electrodes have opposite polarities;

the first auxiliary electrode electrically connects to the first sub pixel electrode, the second sub pixel electrode, the second auxiliary electrode, or other first auxiliary electrode which all have a same driving polarity as the first auxiliary electrode;

the second auxiliary electrode electrically connects to the first sub pixel electrode, the second sub pixel electrode, the first auxiliary electrode, or other second auxiliary electrode which all have the same driving polarity as the second auxiliary electrode;

at least a part of the first sub pixel electrodes are adjacent to each other, and/or at least a part of the second sub pixel electrodes are adjacent to each other.

Optionally, the first auxiliary electrode, the second auxiliary electrode, the first sub pixel electrode, and the second sub pixel electrode on a same column form an electrode column, and the first auxiliary electrode electrically connects to the first sub pixel electrode, the second sub pixel electrode, the second auxiliary electrode, or other first auxiliary electrode which are in the same electrode column and have the same driving polarity as the first auxiliary electrode; the second auxiliary electrode electrically connects to the first sub pixel electrode, the second sub pixel electrode, the first auxiliary electrode, or other second auxiliary electrode which are in the same electrode column and have the same driving polarity as the second auxiliary electrode.

Optionally, the first auxiliary electrode electrically connects to the first sub pixel electrode, the second sub pixel electrode, the second auxiliary electrode, or other first auxiliary electrodes which are in the same electrode column and adjacent to the first auxiliary electrode, and have the same driving polarity as the first auxiliary electrode; the second auxiliary electrode electrically connects to the first sub pixel electrode, the second sub pixel electrode, the first auxiliary electrode, or other second auxiliary electrodes which are in the same electrode column and adjacent to the second auxiliary electrode, and have the same driving polarity as the second auxiliary electrode.

Optionally, each of the first auxiliary electrodes merely surrounds one of the first sub pixel electrodes, and each of the first sub pixel electrodes is surrounded by only one of the first auxiliary electrodes; and

each of the second auxiliary electrodes merely surrounds one of the second sub pixel electrodes, and each of the second sub pixel electrodes is surrounded by only one of the second auxiliary electrodes.

Optionally, the first auxiliary electrode surrounds the first sub pixel electrode to form a ring having a notch, and the second auxiliary electrode surrounds the second sub pixel electrode to form a ring having a notch.

Optionally, the first auxiliary electrode includes a plurality of first strip electrodes connected in sequence, each of the first strip electrodes is adjacent to a side of the first sub pixel electrode and extends along the side of the first sub pixel electrode, and each of the first strip electrodes is defined at a different side of the first sub pixel electrode;

the second auxiliary electrode includes a plurality of second strip electrodes connected in sequence, each of the second strip electrodes is adjacent to a side of the second sub pixel electrode and extends along the side of the second sub pixel electrode, and each of the second strip electrodes is defined at a different side of the second sub pixel electrode.

Optionally, two first sub pixel electrodes and two second sub pixel electrodes are crosswise arranged along a longitudinal direction.

Optionally, the display panel further includes:

a lower substrate and an upper substrate facing the lower substrate;

a liquid crystal layer, defined between the lower substrate and the upper substrate;

a first dielectric layer, defined on the lower substrate;

a plurality of data lines, the data lines extend along a longitudinal direction, and arranged in a transverse direction, the data lines are defined on the first dielectric layer; and

a second dielectric layer, defined on the first dielectric layer and covering the data line;

the first sub pixel electrode, the second sub pixel electrode, the first auxiliary electrode, and the second auxiliary electrode are all defined on the second dielectric layer.

Optionally, the first sub pixel electrode, the second sub pixel electrode, the first auxiliary electrode, and the second auxiliary electrode are made of same material.

The present disclosure further provides a display panel, the display panel includes:

a plurality of first sub pixel electrodes and a plurality of second sub pixel electrodes, the first sub pixel electrodes and the second sub pixel electrodes are arranged in a rectangular array;

a plurality of first auxiliary electrodes, the first auxiliary electrodes at least partially surround the plurality of first sub pixel electrodes, the first auxiliary electrodes and the first sub pixel electrodes have opposite polarities; and

a plurality of second auxiliary electrodes, the second auxiliary electrodes at least partially surround the plurality of second sub pixel electrodes, the second auxiliary electrodes and the second sub pixel electrodes have opposite polarities;

the first auxiliary electrode electrically connects to the first sub pixel electrode, the second sub pixel electrode, the second auxiliary electrode, or other first auxiliary electrode which all have a same driving polarity as the first auxiliary electrode;

the second auxiliary electrode electrically connects to the first sub pixel electrode, the second sub pixel electrode, the first auxiliary electrode, or other second auxiliary electrode which all have the same driving polarity as the second auxiliary electrode;

at least a part of the first sub pixel electrodes are adjacent to each other along a longitudinal direction, and/or at least a part of the second sub pixel electrodes are adjacent to each other along the longitudinal direction;

each of the first auxiliary electrodes merely surrounds one of the first sub pixel electrodes, and each of the first sub pixel electrodes is surrounded by only one of the first auxiliary electrodes;

each of the second auxiliary electrodes merely surrounds one of the second sub pixel electrodes, and each of the second sub pixel electrodes is surrounded by only one of the second auxiliary electrodes.

The present disclosure further provides a display device, the display device includes a display panel, the display panel includes:

a plurality of first sub pixel electrodes and a plurality of second sub pixel electrodes, the first sub pixel electrodes and the second sub pixel electrodes are arranged in a rectangular array;

at least a part of the first sub pixel electrodes are adjacent to each other, and/or at least a part of the second sub pixel electrodes are adjacent to each other;

a plurality of first auxiliary electrodes, the first auxiliary electrodes at least partially surround the plurality of first sub pixel electrodes, the first auxiliary electrodes and the first sub pixel electrodes have opposite polarities; and

a plurality of second auxiliary electrodes, the second auxiliary electrodes at least partially surround the plurality of second sub pixel electrodes, the second auxiliary electrodes and the second sub pixel electrodes have opposite polarities;

the first auxiliary electrode electrically connects to the first sub pixel electrode, the second sub pixel electrode, the second auxiliary electrode, or other first auxiliary electrode which all have a same driving polarity as the first auxiliary electrode;

the second auxiliary electrode electrically connects to the first sub pixel electrode, the second sub pixel electrode, the first auxiliary electrode, or other second auxiliary electrode which all have the same driving polarity as the second auxiliary electrode.

Optionally, the first auxiliary electrode, the second auxiliary electrode, the first sub pixel electrode, and the second sub pixel electrode on a same column form an electrode column, and the first auxiliary electrode electrically connects to the first sub pixel electrode, the second sub pixel electrode, the second auxiliary electrode, or other first auxiliary electrode which are in the same electrode column and have the same driving polarity as the first auxiliary electrode; the second auxiliary electrode electrically connects to the first sub pixel electrode, the second sub pixel electrode, the first auxiliary electrode, or other second auxiliary electrode which are in the same electrode column and have the same driving polarity as the second auxiliary electrode.

Optionally, the first auxiliary electrode electrically connects to the first sub pixel electrode, the second sub pixel electrode, the second auxiliary electrode, or other first auxiliary electrodes which are in the same electrode column and adjacent to the first auxiliary electrode, and have the same driving polarity as the first auxiliary electrode; the second auxiliary electrode electrically connects to the first sub pixel electrode, the second sub pixel electrode, the first auxiliary electrode, or other second auxiliary electrodes which are in the same electrode column and adjacent to the second auxiliary electrode, and have the same driving polarity as the second auxiliary electrode.

Optionally, each of the first auxiliary electrodes merely surrounds one of the first sub pixel electrodes, and each of the first sub pixel electrodes is surrounded by only one of the first auxiliary electrodes; and

each of the second auxiliary electrodes merely surrounds one of the second sub pixel electrodes, and each of the second sub pixel electrodes is surrounded by only one of the second auxiliary electrodes.

Optionally, the first auxiliary electrode surrounds the first sub pixel electrode to form a ring having a notch, and the second auxiliary electrode surrounds the second sub pixel electrode to form a ring having a notch.

Optionally, the first auxiliary electrode includes a plurality of first strip electrodes connected in sequence, each of the first strip electrodes is adjacent to a side of the first sub pixel electrode and extends along the side of the first sub pixel electrode, and each of the first strip electrodes is defined at a different side of the first sub pixel electrode;

the second auxiliary electrode includes a plurality of second strip electrodes connected in sequence, each of the second strip electrodes is adjacent to a side of the second sub pixel electrode and extends along the side of the second sub pixel electrode, and each of the second strip electrodes is defined at a different side of the second sub pixel electrode.

Optionally, two first sub pixel electrodes and two second sub pixel electrodes are crosswise arranged along a longitudinal direction.

Optionally, the display panel further includes:

a lower substrate and an upper substrate facing the lower substrate;

a liquid crystal layer, defined between the lower substrate and the upper substrate;

a first dielectric layer, defined on the lower substrate;

a plurality of data lines, the data lines extend along a longitudinal direction, and arranged in a transverse direction, the data lines are defined on the first dielectric layer; and

a second dielectric layer, defined on the first dielectric layer and covering the data line;

the first sub pixel electrode, the second sub pixel electrode, the first auxiliary electrode, and the second auxiliary electrode are all defined on the second dielectric layer.

In the technical solution of the present disclosure, the first auxiliary electrode is defined at the periphery of each first sub pixel electrode, and the second auxiliary electrode is defined at the periphery of each second sub pixel electrode. Since the first auxiliary electrode and the first sub pixel electrode have opposite polarities, the second auxiliary electrode and the second sub pixel electrode have opposite polarities, so that the edge electric field effect is generated between the first auxiliary electrode and the corresponding first sub pixel electrode to form the inclined electric field direction, liquid crystal molecules with dielectric anisotropy are guided, and liquid crystal molecules are rotated in the direction perpendicular to the inclined electric field direction. The edge electric field effect is generated between the second auxiliary electrode and its corresponding second sub pixel electrode to form the inclined electric field direction, such causing the liquid crystal molecules to rotate in the direction perpendicular to the inclined electric field direction, so that light leakage of the display panel can be avoided, and multiple domains can be formed to increase the arrangement directions of the liquid crystal molecules, and improve the color deviation of the panel and the display quality.

### BRIEF DESCRIPTION OF THE DRAWINGS

FIG. 1 is a structural diagram of an exemplary display panel;

FIG. 2 is a diagram of driving modes of an exemplary display panel and the display panel of the present disclosure in some embodiments;

FIG. 3 is a structural diagram of the display panel of the present disclosure according to some embodiments;

FIG. 4 is a cross-sectional diagram of the display panel along the line M-M shown in FIG. 3;

FIG. 5 is a guide diagram of the liquid crystal molecules in the display panel of the present disclosure when no voltage is applied;

FIG. 6 is a guide diagram of the liquid crystal molecules in the display panel of the present disclosure after the voltage is applied.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, all of the directional instructions in the exemplary embodiments of the present disclosure (such as top, down, left, right, front, back . . . ) can only be used for explaining relative position relations, moving condition of the elements under a special form (referring to figures), and so on, if the special form changes, the directional instructions changes accordingly.

In addition, the descriptions, such as the “first”, the “second” in the exemplary embodiment of present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the “and/or” in the present disclosure means including three paratactic solutions, for example, taking “A and/or B” as an example, the “A and/or B” includes A solution, B solution, or solution of A and B. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

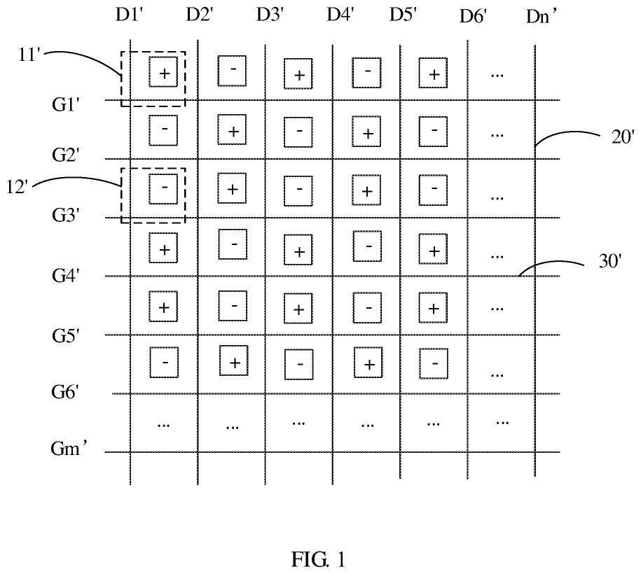

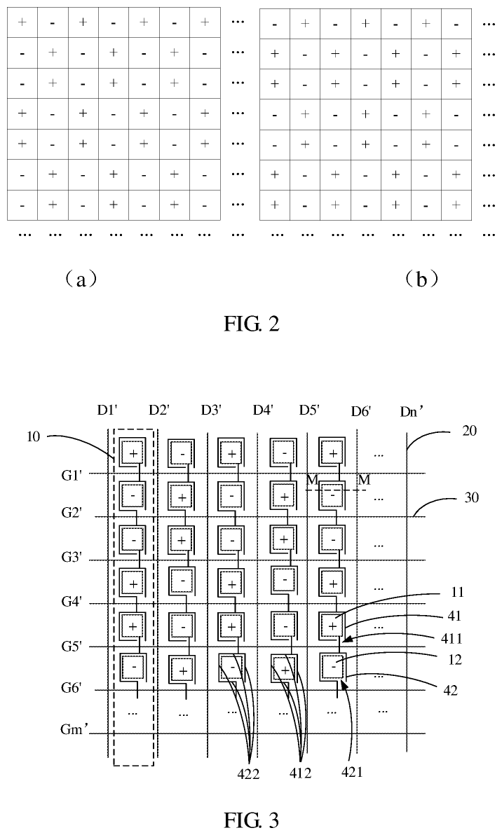

FIG. 1 is a structural diagram of an exemplary display panel, the exemplary display panel includes a plurality of first sub pixels 11′, a plurality of second sub pixels 12′, a plurality of data lines 20′, and a plurality of scan lines 30′. The plurality of first sub pixels 11′ and the plurality of second sub pixels 12′ all include at least three kinds of sub pixels, namely, red sub pixels, green sub pixels, and blue sub pixels, thereby realizing the display of color images through the principle of spatial color mixing. The plurality of first sub pixels 11′ and the plurality of second sub pixels 12′ are arranged in the rectangular array, the first sub pixel 11′ and the second sub pixel 12′ on the same column form a sub pixel column, the data line 20′ is arranged alternately with the sub pixel column, the first sub pixel 11′ and the second sub pixel 12′ on the same row form a sub pixel row, and the scan line 30′ is arranged alternately with the sub pixel row. Under the action of the scan signal Gm′ on the scan line 30′, each row of sub pixels (referring to the first sub pixel 11′ or the second sub pixel 12′) is turned respectively, and when the sub pixels are turned on, the sub pixels are charged under the driving action of the driving signal Dn′ on the data line 20′, thereby displaying a certain brightness. As shown in FIG. 2, FIG. 2 is a specific display panel driving mode, FIG. 2(a) and FIG. 2(b) show the driving polarities applied to sub pixels by the driving signal Dn′ in the adjacent two frame display panels, and the display panel is driven by dot inversion or the like. Then, in a frame time, the polarities of the drive signal Dn on the data line 20′ may change according to the rule of +−−++−− . . . , or −++−−++ . . . , so as to display an image. However, the display panel in this structure has a poor display effect.

The present disclosure provides a display panel. In some embodiments of the present disclosure, as shown in FIG. 3, the display panel includes a plurality of first sub pixels, a plurality of second sub pixels, a plurality of data lines 20, and a plurality of scan lines 30, the data lines 20 extend along the longitudinal direction, and the plurality of data lines 20 are spaced from each other in the transverse direction, the scan lines 30 extend in the transverse direction, and the plurality of scan lines 30 are spaced from each other along the longitudinal direction. Every two adjacent data lines 20 and every two adjacent scan lines 30 defines a distribution area, each of the distribution areas defines one first sub pixel or one second sub pixel is disposed.

Generally, the plurality of first sub pixels and the plurality of second sub pixels all include three sub pixels, namely, red sub pixels, green sub pixels, and blue sub pixels, the three kinds of sub pixels are arranged according to a certain rule to realize the display of color images. As a whole of the display panel, the first sub pixels and the second sub pixels are arranged in the rectangular array, and the first sub pixels and the second sub pixels all on the same column form a sub pixel column which is arranged alternately with the data line 20 extending along the longitudinal direction, so as to realize the electrical connection among the data line 20 and the first sub pixel and the second sub pixel, and to reduce the occurrence of cross line. The first sub pixels and the second sub pixels on the same row form a sub pixel row which is arranged alternately with the scan line 30 extending in the transverse direction, so as to realize the electrical connection among the scan line 30 and the first sub pixel and the second sub pixel, and to reduce the occurrence of cross line.

The first sub pixel includes a first sub pixel electrode 11 and a switch component, the switch component includes a source electrode, a drain electrode, and a gate electrode, the source electrode is electrically connected with the data line 20 corresponding to the first sub pixel, and the drain electrode is electrically connected with the first sub pixel electrode 11. Similarly, the second sub pixel includes a second sub pixel electrode 12 and a switch component which includes a source electrode, a drain electrode, and a gate electrode, the source electrode is electrically connected to the data line 20 corresponding to the second sub pixel, and the drain electrode is electrically connected to the second sub pixel electrode 12. That is, the display panel of the present disclosure includes a plurality of first sub pixel electrodes 11 and a plurality of second sub pixel electrodes 12, the first sub pixel electrodes 11 and the second sub pixel electrodes 12 are arranged in the rectangular array.

In the present disclosure, at least a part of the first sub pixel electrodes 11 are disposed adjacent to each other, and/or at least a part of the second sub pixel electrodes 12 are disposed adjacent to each other. Specifically, at least a part of the first sub pixel electrodes 11 are disposed adjacent to each other along the longitudinal direction or in the transverse direction. Likewise, at least a part of the second sub pixel electrodes 12 are disposed adjacent to each other along the longitudinal direction or in the transverse direction. For example, on the same sub pixel column and in the same frame image, the polarities of the sub pixels can be changed in the form of +−−++−− . . . , or −+++−+++ . . . , etc.

In some embodiments of the present disclosure, the two first sub pixel electrodes 11 and the two second sub pixel electrodes 12 are crosswise arranged along the longitudinal direction, that is, on the same sub pixel column, the upper and lower adjacent sub pixel electrodes of the two first sub pixel electrodes 11 are the second sub pixel electrodes 12, the upper and lower adjacent sub pixel electrodes of the two second sub pixel electrodes 12 are the first sub pixel electrodes 11. On the same sub pixel column, any one of first sub pixel electrodes 11 is located between the other one first sub pixel electrode 11 and one second sub pixel electrode 12, any one of second sub pixel electrodes 12 is located between the other one second sub pixel electrode 12 and one first sub pixel electrode 11. That is to say, on the same sub pixel column and in the same frame image, the polarities of the sub pixels can be changed in the form of +−−++−− . . . , or −++−−++ . . . , or the like, that is, the driving mode of the display panel can be 1+2line or 2line.

The display panel of the present disclosure also includes a plurality of first auxiliary electrodes 41 and a plurality of second auxiliary electrodes 42, the plurality of first auxiliary electrodes 41 at least partially surround the plurality of first sub pixel electrodes 11, and the first auxiliary electrodes 41 and the first sub pixel electrodes 11 have opposite polarities. The plurality of second auxiliary electrodes 42 at least partially surround the plurality of second sub pixel electrodes 12, and the second auxiliary electrodes 42 and the second sub pixel electrodes 12 have opposite polarities. The first auxiliary electrode 41 electrically connects to the first sub pixel electrode 11, the second sub pixel electrode 12, the second auxiliary electrode 42, or other first auxiliary electrodes 41 which have the same driving polarity as the first auxiliary electrode 41. The second auxiliary electrode 42 electrically connects to the first sub pixel electrode 11, the second sub pixel electrode 12, the first auxiliary electrode 41 or other second auxiliary electrode 42 which have the same driving polarity as the second auxiliary electrode 42.

In the embodiments of the present disclosure, the plurality of first auxiliary electrodes 41 at least partially surrounding the plurality of first sub pixel electrodes 11 means that each first auxiliary electrode 41 merely surrounds one first sub pixel electrode 11, and each first sub pixel electrode 11 is surrounded by only one first auxiliary electrode 41. The plurality of second auxiliary electrodes 42 at least partially surrounding the plurality of second sub pixel electrodes 12 means that each second auxiliary electrode 42 merely surrounds one second sub pixel electrode 12, and each second sub pixel electrode 12 is surrounded by only one second auxiliary electrode 42. That is, each first sub pixel electrode 11 is provided with a unique first auxiliary electrode 41, and each second sub pixel electrode 12 is provided with a unique second auxiliary electrode 42. In addition, in other embodiments, each first auxiliary electrode 41 may also surround a plurality of first sub pixel electrodes 11, and each second auxiliary electrode 42 may also surround a plurality of second sub pixel electrodes 12, for example, each first auxiliary electrode 41 may surround two or three or other numbers of first sub pixel electrodes 11, and each second auxiliary electrode 42 may surround two or three or other numbers of second sub pixel electrodes 12.

In the embodiments of the present disclosure, the first auxiliary electrode 41 can be electrically connected to any one of the electrodes having the same driving polarity as the first auxiliary electrode 41, for example, the first auxiliary electrode 41 can be electrically connected to any one of the first sub pixel electrode 11, the second sub pixel electrode 12, the second auxiliary electrode 42, or other first auxiliary electrodes 41 to have the same polarity. Similarly, the second auxiliary electrode 42 can also be electrically connected to any one of the electrodes having the same driving polarity as the second auxiliary electrode 42, for example, the second auxiliary electrode 42 can be electrically connected to any one of the first sub pixel electrode 11, the second sub pixel electrode 12, the first auxiliary electrode 41, or the other second auxiliary electrode 42 to have the same polarity.

In the present disclosure, by providing the first auxiliary electrode 41 at the periphery of each first sub pixel electrode 11 and providing the second auxiliary electrode 42 at the periphery of each second sub pixel electrode 12, since the first auxiliary electrode 41 and the first sub pixel electrode 11 have opposite polarities, and the second auxiliary electrode 42 and the second sub pixel electrode 12 also have opposite polarities, so that the edge electric field effect is generated between the first auxiliary electrode 41 and the corresponding first sub pixel electrode 11 to form the inclined electric field direction, liquid crystal molecules with dielectric anisotropy are guided, and liquid crystal molecules are rotated in the direction perpendicular to the inclined electric field direction. The edge electric field effect is generated between the second auxiliary electrode 42 and its corresponding second sub pixel electrode 12 to form the inclined electric field direction, such causing the liquid crystal molecules to rotate in the direction perpendicular to the inclined electric field direction, so that light leakage of the display panel can be avoided, and multiple domains can be formed to increase the arrangement directions of the liquid crystal molecules, and improve the color deviation of the panel and the display quality.

In some embodiments of the present disclosure, the first auxiliary electrode 41, the second auxiliary electrode 42, the first sub pixel electrode 11, and the second sub pixel electrode 12 on the same column form the electrode column 10, and the first auxiliary electrode 41 electrically connects to the first sub pixel electrode 11, the second sub pixel electrode 12, the second auxiliary electrode 42, or other first auxiliary electrodes 41 which are in the same electrode column 10 and have the same driving polarity as the first auxiliary electrode 41. The second auxiliary electrode 42 electrically connects to the first sub pixel electrode 11, the second sub pixel electrode 12, the first auxiliary electrode 41, or other second auxiliary electrodes 42 which are in the same electrode column 10 and have the same driving polarity as the second auxiliary electrode 42. Specifically, the first auxiliary electrode 41 electrically connects to the first sub pixel electrode 11, the second sub pixel electrode 12, the second auxiliary electrode 42, or other first auxiliary electrodes 41 which are in the same electrode column 10 and adjacent to the first auxiliary electrode 41, and have the same driving polarity as the first auxiliary electrode 41. The second auxiliary electrode 42 electrically connects to the first sub pixel electrode 11, the second sub pixel electrode 12, the first auxiliary electrode 41 or other second auxiliary electrodes 42 which are in the same electrode column 10 and adjacent to the second auxiliary electrode 42, and have the same driving polarity as the second auxiliary electrode 42. Since both the first auxiliary electrode 41 and the second auxiliary electrode 42 are electrically connected to the electrode closest to them, the connecting line between the electrodes has a small span, making the connection between the electrodes more orderly and also facilitating the simplification of the overall structure.

In other embodiments of the present disclosure, the first auxiliary electrode 41, the second auxiliary electrode 42, the first sub pixel electrode 11, and the second sub pixel electrode 12 on the same row form a sub pixel row, and the first auxiliary electrode 41 electrically connects to the first sub pixel electrode 11, the second sub pixel electrode 12, the second auxiliary electrode 42 or other first auxiliary electrodes 41 which are in the same sub pixel row and have the same driving polarity as the first auxiliary electrode 41. The second auxiliary electrode 42 electrically connects to the first sub pixel electrode 11, the second sub pixel electrode 12, the first auxiliary electrode 41 or other second auxiliary electrodes 42 which are in the same sub pixel row and have the same driving polarity as the second auxiliary electrode 42.

In some embodiments of the present disclosure, the first auxiliary electrode 41 surrounds the first sub pixel electrode 11 to form a notch 411 with a ring shape, the electrical connection line electrically connected to the first sub pixel electrode 11 passes through the notch 411. The second auxiliary electrode 42 surrounds the second sub pixel electrode 12 to form a notch 421 with a ring shape, the electrical connection line electrically connected to the second sub pixel electrode 12 passes through the notch 421. By making both the first auxiliary electrode 41 and the second auxiliary electrode 42 to be ring shaped, it is possible to make the first sub pixel electrode 11 and the second sub pixel electrode 12 to be surrounded much more completely, ensuring that the edge electric fields are formed around the first sub pixel electrode 11 and around the second sub pixel electrode 12.

In some embodiments, both the first auxiliary electrode 41 and the second auxiliary electrode 42 may have a circular ring shape, a square ring shape, or the like. Specifically, the first auxiliary electrode 41 includes a plurality of first strip electrodes 412 connected in sequence, each of the first strip electrodes 412 is adjacent to a side of the first sub pixel electrode 11 and extends along the side of the first sub pixel electrode 11, and each of the first strip electrodes 412 is defined at a different side of the first sub pixel electrode 11. The second auxiliary electrode 42 includes a plurality of second strip electrodes 422 connected in sequence, each second strip electrode 422 is adjacent to a side of the second sub pixel electrode 12 and extends along the side of the second sub pixel electrode 12, and each second strip electrode 422 is defined at a different side of the second sub pixel electrode 12. For example, the first auxiliary electrode 41 includes four first strip electrodes 412, which respectively correspond to left side, right side, upper side, and lower side of the first sub pixel electrode 11, the second auxiliary electrode 42 includes four second strip electrodes 422, which respectively correspond to left side, right side, upper side, and lower side of the second sub pixel electrode 12. In some embodiments, since the four sides of one sub pixel electrode are respectively surrounded by four strip electrodes, and the corresponding strip electrodes are parallel to the side edges of the sub pixel electrodes, the edge electric field generated between each sub pixel electrode and each auxiliary electrode can generate four different incline electric field directions, so that surrounding the liquid crystal molecules can simultaneously incline toward the center to generate four different incline directions of liquid crystal molecules, and the effect of dividing four liquid crystal micro domains with different incline directions can be obtained.

In other embodiments of the present disclosure, the auxiliary electrode may only partially surround the sub pixel electrode, for example, the auxiliary electrode may also include only one strip electrode, two strip electrodes, or three strip electrodes.

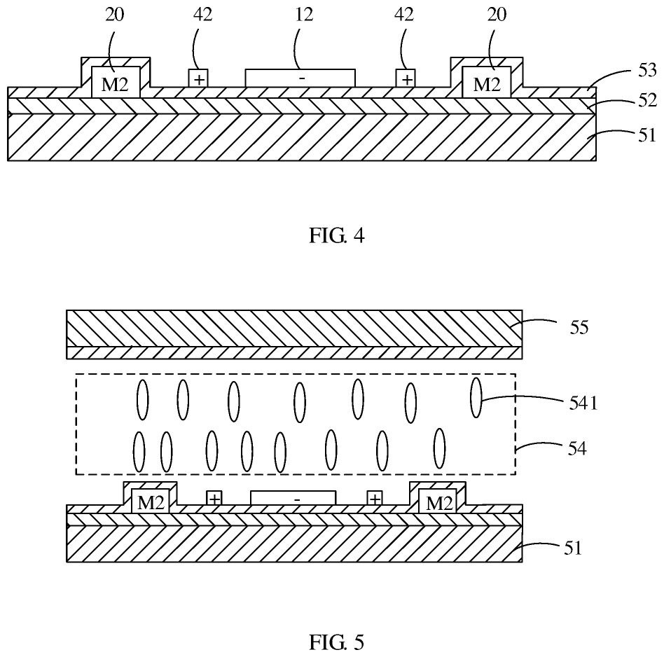

Referring to FIGS. 4 to 6, furthermore, the display panel further includes a lower substrate 51, an upper substrate 55, and a liquid crystal layer 54, the lower substrate 51 faces the upper substrate 55, the liquid crystal layer 54 is defined between the lower substrate 51 and the upper substrate 55, and the liquid crystal layer 54 includes a plurality of liquid crystal molecules 541. A first dielectric layer 52 is provided on the lower substrate 51, and the data lines 20 are defined on the first dielectric layer 52. A second dielectric layer 53 is also defined on the first dielectric layer 52, and the second dielectric layer 53 covers the data line 20. The first sub pixel electrode 11, the second sub pixel electrode 12, the first auxiliary electrode 41, and the second auxiliary electrode 42 are all defined on the second dielectric layer 53. In some embodiments, the first sub pixel electrode 11, the second sub pixel electrode 12, the first auxiliary electrode 41, and the second auxiliary electrode 42 are all defined in the same layer. When the auxiliary electrode and the pixel electrode are made of the same material (e.g., transparent conductive film), the auxiliary electrode itself also forms a part of the display region, so the auxiliary electrode can be regarded as an extension of the pixel electrode.

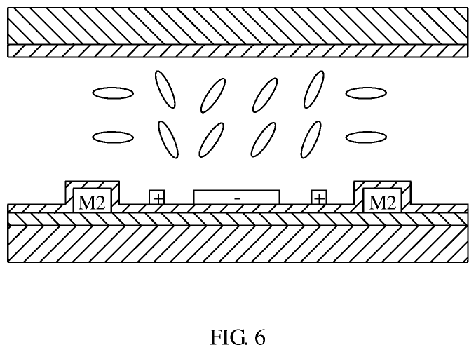

FIG. 5 is a guide diagram of the liquid crystal molecules, the liquid crystal molecules 541 are naturally aligned perpendicular to the lower substrate 51 and the upper substrate when no voltage is applied. FIG. 6 is a guide diagram of the liquid crystal molecules after the voltage is applied. After the voltage is applied, the edges of the auxiliary electrode and the pixel electrode may generate the edge incline electric field due to their opposite polarities, and the liquid crystal molecules 541 may be aligned perpendicular to the direction of the edge electric field. Each sub pixel electrode is surrounded by the auxiliary electrode, so there may be four directions for one sub pixel liquid crystal molecule, so as to form four domains.

In some embodiments of the present disclosure, the first sub pixel electrode 11, the second sub pixel electrode 12, the first auxiliary electrode 41, and the second auxiliary electrode 42 are made of the same material, for example, the first sub pixel electrode 11, the second sub pixel electrode 12, the first auxiliary electrode 41, and the second auxiliary electrode 42 are made of transparent conductive material such as indium tin oxide (ITO).

The present disclosure also provides a display device, which includes a display panel and a driving component, the driving component is electrically connected with the data line 20, and the driving component is configured to output a driving signal to the data line 20. The specific structure of the display panel can be referred to the above embodiments. As the display device adopts all the technical proposals of the above exemplary embodiments, no need to repeat again.

The foregoing description merely depicts some embodiments of the present disclosure and therefore is not intended to limit the scope of the present disclosure. An equivalent structural or flow changes made by using the content of the specification and drawings of the present disclosure, or any direct or indirect present disclosures of the disclosure on any other related fields shall all fall in the scope of the present disclosure.

What is claimed is:

1. A display panel, wherein the display panel comprises:
a plurality of first sub pixel electrodes and a plurality of second sub pixel electrodes, the first sub pixel electrodes and the second sub pixel electrodes are arranged in a rectangular array;
a plurality of first auxiliary electrodes, the first auxiliary electrodes at least partially surround the plurality of first sub pixel electrodes, the first auxiliary electrodes and the first sub pixel electrodes have opposite polarities; and
a plurality of second auxiliary electrodes, the second auxiliary electrodes at least partially surround the plurality of second sub pixel electrodes, the second auxiliary electrodes and the second sub pixel electrodes have opposite polarities;
wherein the first auxiliary electrode electrically connects to the first sub pixel electrode, the second sub pixel electrode, the second auxiliary electrode, or other first auxiliary electrode which all have a same driving polarity as the first auxiliary electrode;
the second auxiliary electrode electrically connects to the first sub pixel electrode, the second sub pixel electrode, the first auxiliary electrode, or other second auxiliary electrode which all have the same driving polarity as the second auxiliary electrode;
at least a part of the first sub pixel electrodes are adjacent to each other, and/or at least a part of the second sub pixel electrodes are adjacent to each other.

2. The display panel according to claim 1, wherein the first auxiliary electrode, the second auxiliary electrode, the first sub pixel electrode, and the second sub pixel electrode on a same column form an electrode column, and the first auxiliary electrode electrically connects to the first sub pixel electrode, the second sub pixel electrode, the second auxiliary electrode, or other first auxiliary electrode which are in the same electrode column and have the same driving polarity as the first auxiliary electrode; the second auxiliary electrode electrically connects to the first sub pixel electrode, the second sub pixel electrode, the first auxiliary electrode, or other second auxiliary electrode which are in the same electrode column and have the same driving polarity as the second auxiliary electrode.

3. The display panel according to claim 2, wherein the first auxiliary electrode electrically connects to the first sub pixel electrode, the second sub pixel electrode, the second auxiliary electrode, or other first auxiliary electrodes which are in the same electrode column and adjacent to the first auxiliary electrode, and have the same driving polarity as the first auxiliary electrode; the second auxiliary electrode electrically connects to the first sub pixel electrode, the second sub pixel electrode, the first auxiliary electrode, or other second auxiliary electrodes which are in the same electrode column and adjacent to the second auxiliary electrode, and have the same driving polarity as the second auxiliary electrode.

4. The display panel according to claim 1, wherein each of the first auxiliary electrodes merely surrounds one of the first sub pixel electrodes, and each of the first sub pixel electrodes is surrounded by only one of the first auxiliary electrodes; and
each of the second auxiliary electrodes merely surrounds one of the second sub pixel electrodes, and each of the second sub pixel electrodes is surrounded by only one of the second auxiliary electrodes.

5. The display panel according to claim 4, wherein the first auxiliary electrode surrounds the first sub pixel electrode to form a ring having a notch, and the second auxiliary electrode surrounds the second sub pixel electrode to form a ring having a notch.

6. The display panel according to claim 5, wherein the first auxiliary electrode comprises a plurality of first strip electrodes connected in sequence, each of the first strip electrodes is adjacent to a side of the first sub pixel electrode and extends along the side of the first sub pixel electrode, and each of the first strip electrodes is defined at a different side of the first sub pixel electrode;
the second auxiliary electrode comprises a plurality of second strip electrodes connected in sequence, each of the second strip electrodes is adjacent to a side of the second sub pixel electrode and extends along the side of the second sub pixel electrode, and each of the second strip electrodes is defined at a different side of the second sub pixel electrode.

7. The display panel according to claim 1, wherein two first sub pixel electrodes and two second sub pixel electrodes are crosswise arranged along a longitudinal direction.

8. The display panel of claim 1, wherein the display panel further comprises:
a lower substrate and an upper substrate facing the lower substrate;
a liquid crystal layer, defined between the lower substrate and the upper substrate;
a first dielectric layer, defined on the lower substrate;
a plurality of data lines, the data lines extend along a longitudinal direction, and arranged in a transverse direction, the data lines are defined on the first dielectric layer; and
a second dielectric layer, defined on the first dielectric layer and covering the data line;
the first sub pixel electrode, the second sub pixel electrode, the first auxiliary electrode, and the second auxiliary electrode are all defined on the second dielectric layer.

9. The display panel according to claim 1, wherein the first sub pixel electrode, the second sub pixel electrode, the first auxiliary electrode, and the second auxiliary electrode are made of same material.

10. A display panel, wherein the display panel comprises:
a plurality of first sub pixel electrodes and a plurality of second sub pixel electrodes, the first sub pixel electrodes and the second sub pixel electrodes are arranged in a rectangular array;
a plurality of first auxiliary electrodes, the first auxiliary electrodes at least partially surround the plurality of first sub pixel electrodes, the first auxiliary electrodes and the first sub pixel electrodes have opposite polarities; and
a plurality of second auxiliary electrodes, the second auxiliary electrodes at least partially surround the plurality of second sub pixel electrodes, the second auxiliary electrodes and the second sub pixel electrodes have opposite polarities;
wherein the first auxiliary electrode electrically connects to the first sub pixel electrode, the second sub pixel electrode, the second auxiliary electrode, or other first auxiliary electrode which all have a same driving polarity as the first auxiliary electrode;
the second auxiliary electrode electrically connects to the first sub pixel electrode, the second sub pixel electrode, the first auxiliary electrode, or other second auxiliary electrode which all have the same driving polarity as the second auxiliary electrode;
at least a part of the first sub pixel electrodes are adjacent to each other along a longitudinal direction, and/or at least a part of the second sub pixel electrodes are adjacent to each other along the longitudinal direction;
each of the first auxiliary electrodes merely surrounds one of the first sub pixel electrodes, and each of the first sub pixel electrodes is surrounded by only one of the first auxiliary electrodes;
each of the second auxiliary electrodes merely surrounds one of the second sub pixel electrodes, and each of the second sub pixel electrodes is surrounded by only one of the second auxiliary electrodes.

11. A display device, wherein the display device comprises a display panel, the display panel comprises:
a plurality of first sub pixel electrodes and a plurality of second sub pixel electrodes, the first sub pixel electrodes and the second sub pixel electrodes are arranged in a rectangular array;
a plurality of first auxiliary electrodes, the first auxiliary electrodes at least partially surround the plurality of first sub pixel electrodes, the first auxiliary electrodes and the first sub pixel electrodes have opposite polarities; and
a plurality of second auxiliary electrodes, the second auxiliary electrodes at least partially surround the plurality of second sub pixel electrodes, the second auxiliary electrodes and the second sub pixel electrodes have opposite polarities;
wherein the first auxiliary electrode electrically connects to the first sub pixel electrode, the second sub pixel electrode, the second auxiliary electrode, or other first auxiliary electrode which all have a same driving polarity as the first auxiliary electrode;
the second auxiliary electrode electrically connects to the first sub pixel electrode, the second sub pixel electrode, the first auxiliary electrode, or other second auxiliary electrode which all have the same driving polarity as the second auxiliary electrode;
at least a part of the first sub pixel electrodes are adjacent to each other, and/or at least a part of the second sub pixel electrodes are adjacent to each other.

12. The display device according to claim 11, wherein the first auxiliary electrode, the second auxiliary electrode, the first sub pixel electrode, and the second sub pixel electrode on a same column form an electrode column, and the first auxiliary electrode electrically connects to the first sub pixel electrode, the second sub pixel electrode, the second auxiliary electrode, or other first auxiliary electrode which are in the same electrode column and have the same driving polarity as the first auxiliary electrode; the second auxiliary electrode electrically connects to the first sub pixel electrode, the second sub pixel electrode, the first auxiliary electrode, or other second auxiliary electrode which are in the same electrode column and have the same driving polarity as the second auxiliary electrode.

13. The display device according to claim 12, wherein the first auxiliary electrode electrically connects to the first sub pixel electrode, the second sub pixel electrode, the second auxiliary electrode, or other first auxiliary electrodes which are in the same electrode column and adjacent to the first auxiliary electrode, and have the same driving polarity as the first auxiliary electrode; the second auxiliary electrode electrically connects to the first sub pixel electrode, the second sub pixel electrode, the first auxiliary electrode, or other second auxiliary electrodes which are in the same electrode column and adjacent to the second auxiliary electrode, and have the same driving polarity as the second auxiliary electrode.

14. The display device according to claim 11, wherein each of the first auxiliary electrodes merely surrounds one of the first sub pixel electrodes, and each of the first sub pixel electrodes is surrounded by only one of the first auxiliary electrodes; and
each of the second auxiliary electrodes merely surrounds one of the second sub pixel electrodes, and each of the second sub pixel electrodes is surrounded by only one of the second auxiliary electrodes.

15. The display device according to claim 14, wherein the first auxiliary electrode surrounds the first sub pixel electrode to form a ring having a notch, and the second auxiliary electrode surrounds the second sub pixel electrode to form a ring having a notch.

16. The display device according to claim 15, wherein the first auxiliary electrode comprises a plurality of first strip electrodes connected in sequence, each of the first strip electrodes is adjacent to a side of the first sub pixel electrode and extends along the side of the first sub pixel electrode, and each of the first strip electrodes is defined at a different side of the first sub pixel electrode;
the second auxiliary electrode comprises a plurality of second strip electrodes connected in sequence, each of the second strip electrodes is adjacent to a side of the second sub pixel electrode and extends along the side of the second sub pixel electrode, and each of the second strip electrodes is defined at a different side of the second sub pixel electrode.

17. The display device according to claim 11, wherein two first sub pixel electrodes and two second sub pixel electrodes are crosswise arranged along a longitudinal direction.

18. The display device of claim 11, wherein the display panel further comprises:
a lower substrate and an upper substrate facing the lower substrate;
a liquid crystal layer, defined between the lower substrate and the upper substrate;
a first dielectric layer, defined on the lower substrate;
a plurality of data lines, the data lines extend along a longitudinal direction, and arranged in a transverse direction, the data lines are defined on the first dielectric layer; and
a second dielectric layer, defined on the first dielectric layer and covering the data line;
the first sub pixel electrode, the second sub pixel electrode, the first auxiliary electrode, and the second auxiliary electrode are all defined on the second dielectric layer.
